(19) United States
(12) Patent Application Publication
(10) Pub. No.: US 2011/0215140 A1
(43) Pub. Date: Sep. 8, 2011

(54) RECHARGING PREPAID ACCOUNTS

(75) Inventor: Sven Robert Westin, Lomma (SE)

(73) Assignee: SONY ERICSSON MOBILE COMMUNICATIONS AB, Lund (SE)

(21) Appl. No.: 12/768,926

(22) Filed: Apr. 28, 2010

Related U.S. Application Data
(60) Provisional application No. 61/310,122, filed on Mar. 3, 2010.

(51) Int. Cl. G06K 5/00; G06Q 40/00

(52) U.S. Cl. 235/379

(57) ABSTRACT

A method may include reading a barcode and decoding the barcode to obtain a refill code at a user device, receiving an identification number and the refill code from the user device, determining whether the refill code is valid, and determining whether the identification number is valid when the refill code is valid. In addition, the method may include, when the identification number is valid, initiating a payment transaction to refill a prepaid card account. Further, the method may include receiving a user confirmation of the payment transaction when the application is at the network address, and completing the payment transaction and refilling the prepaid account when the user input confirms the payment transaction.

### RELATED APPLICATION

This application claims priority under 35 U.S.C.§119 based on U.S. Provisional Patent Application No. 61/310,122, filed Mar. 3, 2010, the disclosure of which is incorporated by reference herein in its entirety.

### BACKGROUND

A prepaid card (e.g., a Subscriber Identity Module (SIM) card) is typically associated with an account. Furthermore, such an account is associated with a value that is physically stored at either the card or a remote memory (e.g., a file server, networked computer, etc.). When a vendor provides a product or service in connection with the account, the vendor may debit the account, changing the value stored at either the physical card or the remote memory.

### SUMMARY

According to one aspect, a method may include reading a barcode and decoding the barcode to obtain a refill code at a user device, receiving an identification number and the refill code from the user device, determining whether the refill code is valid, and determining whether the identification number is valid when the refill code is valid. Additionally, the method may include, when the identification number is valid, initiating a payment transaction to refill a prepaid card account. Additionally, the method may include receiving a user confirmation of the payment transaction when the application is at the network address, and completing the payment transaction and refilling the prepaid account when the user input confirms the payment transaction.

Additionally, initiating the payment transaction may include retrieving a credit card number registered to the identification number.

Additionally, receiving the user confirmation may include receiving a credit card number from a user when the credit card number is not registered to the identification number.

Additionally, completing the payment transaction may include charging a credit card account associated with the credit card number.

Additionally, receiving the user confirmation may include receiving indication, from a user, that the user approves the payment transaction.

Additionally, reading the barcode may include reading a two-dimensional barcode.

Additionally, reading the barcode may include reading a barcode printed on a magazine or a poster.

Additionally, determining whether the refill code is valid may include determining whether the refill code represents a valid dollar amount.

Additionally, determining whether the refill code is valid may includes determining, by a gateway, whether the refill code is valid, and determining whether the identification number is valid may include determining, by a remote device, whether the identification number exists at the remote device.

According to yet another aspect, a device may include a subscriber identity module (SIM) card associated with a telephone number, a network interface to communicate with a gateway, and a processor. The processor may be configured to decode a barcode to obtain a refill code, send the telephone number and the refill code to the gateway via the network interface, and receive, from the gateway, a network address at which a confirmation page for a payment transaction is presented when the gateway validates the refill code and a remote device validates the telephone number. The processor may be further configure to receive, via a browser installed on the device, a request to confirm the payment transaction at the network address, receive user input confirming the payment transaction, and relay, to the network address, the user input that completes the payment transaction and refills a prepaid account.

Additionally, the prepaid account may include an account that is associated with a prepaid card.

Additionally, the prepaid card may include a prepaid SIM card.

Additionally, the device may include a cellular phone.

Additionally, the processor may be further configured to receive a credit card number of a user when the credit card number is not registered to the telephone number.

Additionally, the device may further include a camera to scan the barcode.

According to yet another aspect, a device may include a network interface and a processor. The processor may be configured to receive a refill code and an identification number from a user device via the network interface, validate the refill code, send the identification number to a server device when the refill code is valid, receive a network address from the server device when the server device determines that identification number is valid and initiates a transaction to refill a prepaid card account, the network address being associated with a web page via which the user device confirms the payment transaction. The processor may be further configured to relay the network address to the user device.

Additionally, the user device may include a cellular telephone.

Additionally, the prepaid card account may include an account associated with a subscriber identity module (SIM) card.

Additionally, the web page may be configured to receive user input that aborts the transaction.

Additionally, the web page may be configured to receive a credit card number that is registered to the identification number.

### BRIEF DESCRIPTION OF THE DRAWINGS

The accompanying drawings, which are incorporated in and constitute a part of this specification, illustrate one or more embodiments described herein and, together with the description, explain the embodiments. In the drawings:

FIG. 1 is a diagram of an exemplary system in which concepts described herein may be implemented;

FIGS. 2A and 2B are front and rear views of an exemplary user device of FIG. 1;

FIG. 3 is a block diagram of exemplary components of network device of FIG. 1;

FIG. 4A is a block diagram of an exemplary functional component of the user device of FIG. 1;

FIG. 4B is a diagram of exemplary 2-Dimensional barcodes;

FIG. 5 is a flow diagram of an exemplary process associated refilling a prepaid account;

FIG. 6 illustrates the process of FIG. 5;

FIG. 7 is a flow diagram of another exemplary process associated with refilling the prepaid account;

FIG. 8 illustrates the process of FIG. 7.

### DETAILED DESCRIPTION

The following detailed description refers to the accompanying drawings. The same reference numbers in different drawings may identify the same or similar elements. As used herein, terms such as “recharge,” “top up,” “refill,” or “reload” may refer to, but is not limited to purchasing credits for a prepaid account. The prepaid account may be used for making a purchase or employing a service (e.g., placing a telephone call using a prepaid card). In some instances, a prepaid account may be associated with a prepaid card or device (e.g., a subscriber identity module (SIM) card, prepaid cell phone, etc.). As used herein, the term “identification number” and “identification code” may be used synonymously. An identification number/code may not only include numeric digits, but alphanumeric characters and/or other symbols.

In the following, a user may conveniently refill a prepaid user account and charge the prepayment to the user's credit card. In refilling the prepaid user account, network devices may provide appropriate automatic authentication of user information (e.g., credit card information, identification number (e.g., phone number), etc.).

In some implementations, a user may refill a prepaid account by scanning a barcode representing a cash value. The barcodes may have been printed, displayed, and/or circulated on material (e.g., a page in a popular magazine, poster, etc.) that is capable of advertising and being scanned via a camera on the user device. When the user determines that a prepaid account is low on credit, the user may scan the barcode corresponding to the desired amount/level of cash and refill the prepaid account. These implementations may allow users to refill prepaid accounts themselves, without having to wait in a line at a kiosk or store to purchase a desired amount of credit.

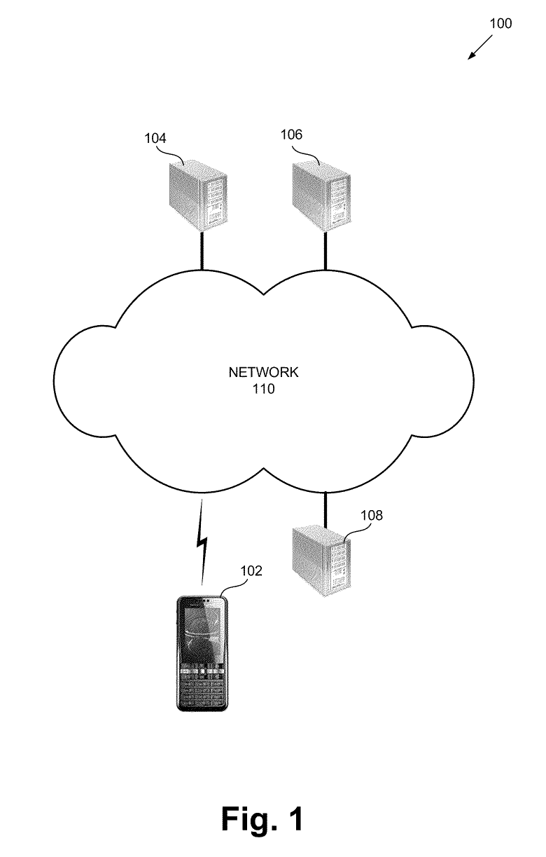

FIG. 1 is a diagram of an exemplary system in which concepts described herein may be implemented. As shown, system 100 may include a user device 102, gateway 104, information verification (IV) device 106, transaction device 108, and network 110.

User device 102 may employ a service, used to make a purchase, and/or perform an activity which decreases the value associated with a prepaid account (e.g., place a telephone call). In addition, user device 102 may facilitate a user in refilling the prepaid account. For example, in some implementations, user device 102 may be capable of scanning two-dimensional (2D) barcodes (e.g., Semacode). Upon scanning and decoding a barcode, user device 102 may initiate a process to refill the prepaid account. In another implementation, user device 102 may include a client application for initiating a refilling process.

Gateway 104 may receive, from user device 102, over network 110, “refill code,” or information that is associated with the initiation of a refilling process (e.g., data obtained from decoding a barcode). In addition, gateway 104 may receive prepaid account information (e.g., cellular identification number (e.g., phone number)). Upon detecting a valid refill code, gateway 104 may relay the prepaid account information to IV device 106.

IV device 106 may receive prepaid account information, verify the prepaid account information (e.g., whether an identification number (e.g., phone number) exists), and retrieve from its database, if available, credit card information registered with the prepaid account (e.g., a credit card number registered with an identification number (e.g., phone number)). In addition, IV device 106 may initiate a process for charging, to the credit card, a payment for refilling the prepaid account.

Transaction device 108 may receive a confirmation from user device 102 that a payment for refilling a prepaid account is to be charged to a credit card and complete the credit card transaction. This may entail additional activity, such as sending an electronic receipt to an email address, etc.

Network 110 may include a cellular network, a public switched telephone network (PSTN), a local area network (LAN), a wide area network (WAN), a wireless LAN, a metropolitan area network (MAN), a Long Term Evolution (LTE) network, an intranet, the Internet, a satellite-based network, a fiber-optic network (e.g., passive optical networks (PONs)), an ad hoc network, any other network, or a combination of networks. Devices that are shown in FIG. 1 may connect to network 110 via wireless, wired, or optical communication links. In addition, network 110 may allow any of devices 102-108 to communicate with any other device 102, 104, 106, or 108.

In FIG. 1, system 100 is illustrated for simplicity and ease of understanding. Although not shown, system 100 may include other types of devices, such as routers, bridges, servers, mobile computers, etc. In addition, depending on the implementation, system 100 may include additional, fewer, or different devices than the ones illustrated in FIG. 1. For example, in some embodiments, system 100 may include hundreds, thousands, or more user devices, additional gateways, IV devices, transaction devices, etc. In another example, the functionalities of gateway 104, IV device 106, and transaction device 108 may be provided via one or two devices.

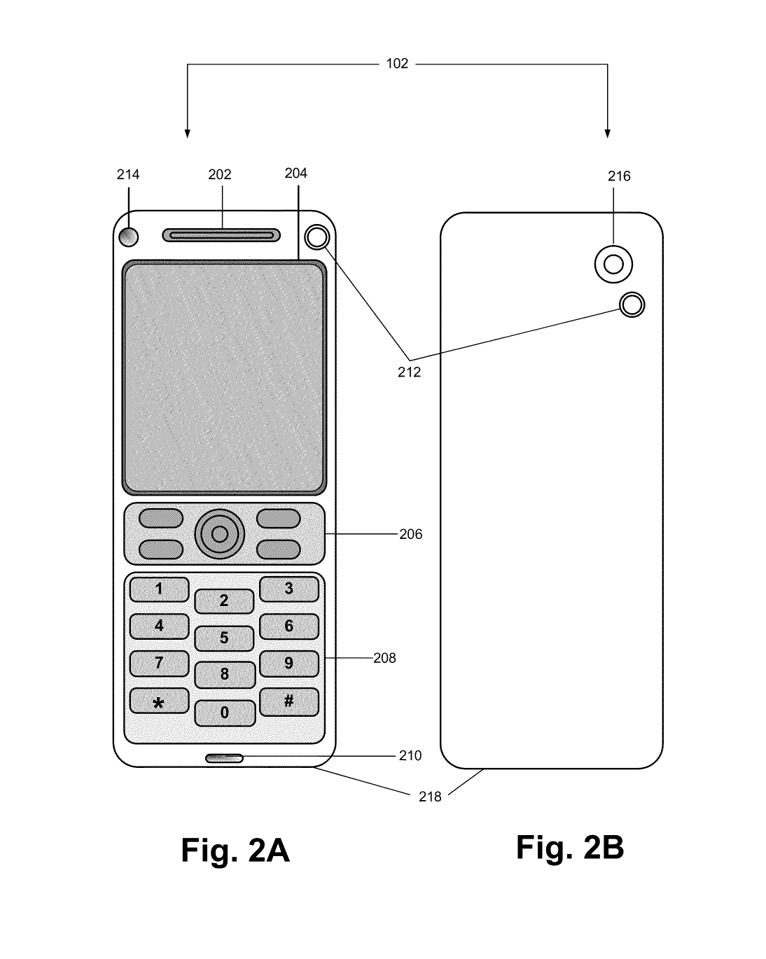

FIGS. 2A and 2B are front and rear views, respectively, of user device 102. User device 102 may include any of the following device: a mobile telephone; a cellular phone; a personal communications system (PCS) terminal that may combine a cellular radiotelephone with data processing, facsimile, and/or data communications capabilities; a laptop; a personal digital assistant (PDA) that can include a telephone; a gaming device or console; a peripheral (e.g., wireless headphone); a digital camera; or another type of computational or communication device. Depending on the implementation, user device 102 may use Universal Mobile Telecommunications system (UMTS) network, Global System for Mobile Telecommunications (GSM) network, etc.

In this implementation, user device 102 may take the form of a portable phone (e.g., a cellular phone). As shown in FIGS. 2A and 2B, user device 102 may include a speaker 202, a display 204, control buttons 206, a keypad 208, a microphone 210, sensors 212, a front camera 214, a rear camera 216, and a housing 218. Speaker 202 may provide audible information to a user of user device 102. Display 204 may provide visual information to the user, such as an image of a caller, video images received via rear camera 216 (e.g., 2D barcodes), or pictures. In some implementations, display 204 may include a touch screen via which user device 102 receives user input (e.g., a selection of payment amount for refilling a prepaid account).

Control buttons 206 may permit the user to interact with user device 102 to cause user device 102 to perform one or more operations, such as place or receive a telephone call, etc. Keypad 208 may include a standard telephone keypad. Microphone 210 may receive audible information from the user and/or the surroundings. Sensors 212 may collect and provide, to user device 102, information (e.g., acoustic, infrared, etc.) that is used to aid the user in capturing images or in providing other types of information (e.g., a distance between a user and user device 202-x).

Front camera 214 and rear camera 216 may enable a user to view, capture and store, and process images (e.g., capture and decode a 2D barcode) of a subject in/at front/back of user device 102. Front camera 214 may be separate from rear camera 216 that is located on the back of user device 102. Housing 218 may provide a casing for components of user device 102 and may protect the components from outside elements.

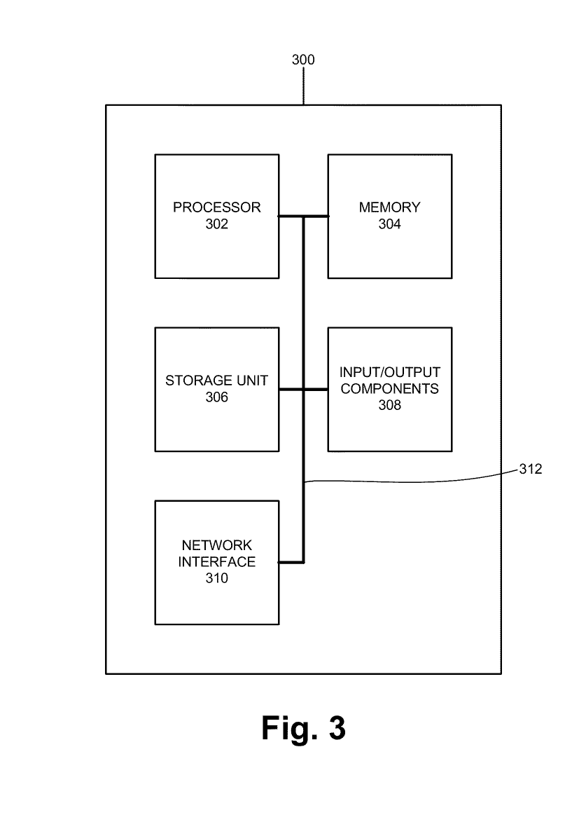

FIG. 3 is a block diagram of exemplary components of a network device 300, which may represent any of devices 102-108. As shown in FIG. 3, network device 300 may include a processor 302, a memory 304, storage unit 306, input/output components 308, a network interface 310, and a communication path 312.

Processor 302 may include a processor, a microprocessor, an Application Specific Integrated Circuit (ASIC), a Field Programmable Gate Array (FPGA), and/or other processing logic (e.g., audio/video processor) capable of processing information and/or controlling network device 300. Memory 304 may include static memory, such as read only memory (ROM), and/or dynamic memory, such as random access memory (RAM), or onboard cache, for storing data and machine-readable instructions. Storage unit 306 may include storage devices, such as a floppy disk, CD ROM, CD read/write (R/W) disc, and/or flash memory, as well as other types of storage devices.

Input/output components 308 may include a display screen (e.g., display 204), a keyboard, a mouse, a speaker, a microphone, a Digital Video Disk (DVD) writer, a DVD reader, Universal Serial Bus (USB) port, and/or other types of components for converting physical events or phenomena to and/or from digital signals that pertain to network device 300.

Network interface 310 may include a transceiver that enables network device 300 to communicate with other devices and/or systems. For example, network interface 408 may communicate via a network, such as the Internet, a terrestrial wireless network (e.g., a WLAN), a cellular network, a satellite-based network, a wireless personal area network (WPAN), etc. Additionally or alternatively, network interface 310 may include a modem, an Ethernet interface to a LAN, and/or an interface/connection for connecting network device 300 to other devices (e.g., a Bluetooth interface).

Communication path 312 may provide an interface through which components of network device 300 can communicate with one another.

In different implementations, network device 300 may include additional, fewer, or different components than the ones illustrated in FIG. 3. For example, network device 300 may include additional network interfaces, such as interfaces for receiving and sending data packets. In another example, a user device 102 may include subscriber identity module (SIM) or another type of card/device/component that is associated with a prepaid account.

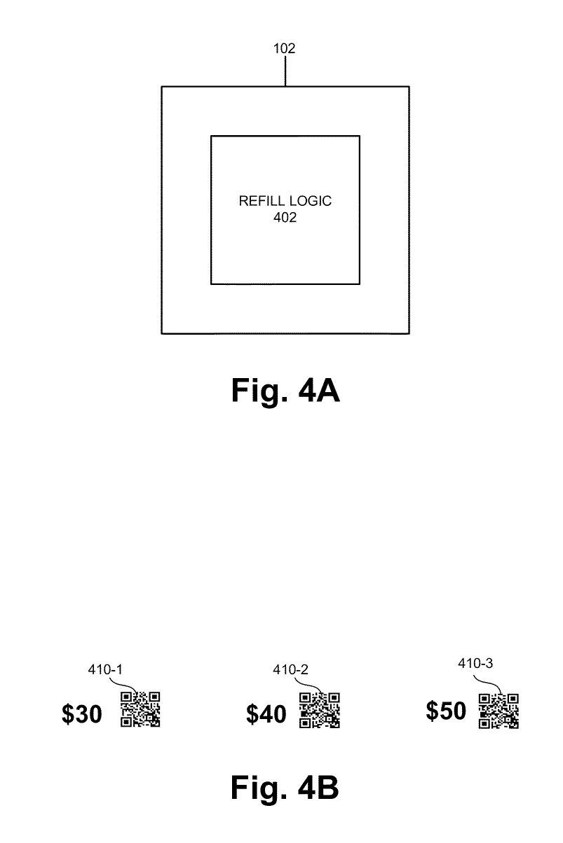

FIG. 4A is a block diagram of exemplary functional components of user device 102. As shown, user device 102 may include refill logic 402. Because FIG. 4A is provided for simplicity and ease of understanding, FIG. 4A does not show or illustrate other components, such as an operating system, document application, game application, etc.

In some embodiments, when a user scans a barcode with user device 102, refill logic 402 in user device 102 may identify and decode the barcode into the corresponding refill code. The refill code may indicate how much (e.g., $30, $40, etc.) credit the prepaid account is to receive. Subsequently, refill logic 402 may send prepaid account information (e.g., information (e.g., phone number, account number, identification number, etc.) stored in a SIM card of user device 102) and the refill code to gateway 104. Refill logic 402 may then receive a reply, from either gateway 104 or IV device 106, that includes a web address (e.g., Universal Resource Locator (URL)) to which a browser or another application on user device 102 is to be directed. Once at the site, the user may be prompted to validate or reject the payment transaction.

FIG. 4B is a diagram of exemplary 2D barcode 410 for refilling a prepaid account. As shown, barcodes 410 may include barcodes for different amounts, such as $30 barcode 410-1, $40 barcode 410-2, and $50 barcode 410-3. Barcodes for other amounts may be implemented.

In some implementations, barcodes 410 may be printed, displayed, and/or circulated on material (e.g., a page in a popular magazine) that is capable of advertising and being scanned via cameras on user device 102. For example, barcodes 410 may be printed on a poster in a grocery store, subway station, etc. When a user 402 determines that a prepaid account is low on credit, the user may scan a barcode corresponding to the desired amount/level of credit. Therefore, these implementations allow users to refill prepaid accounts themselves, without having to wait in a line at a kiosk or store to purchase a desired amount of credit.

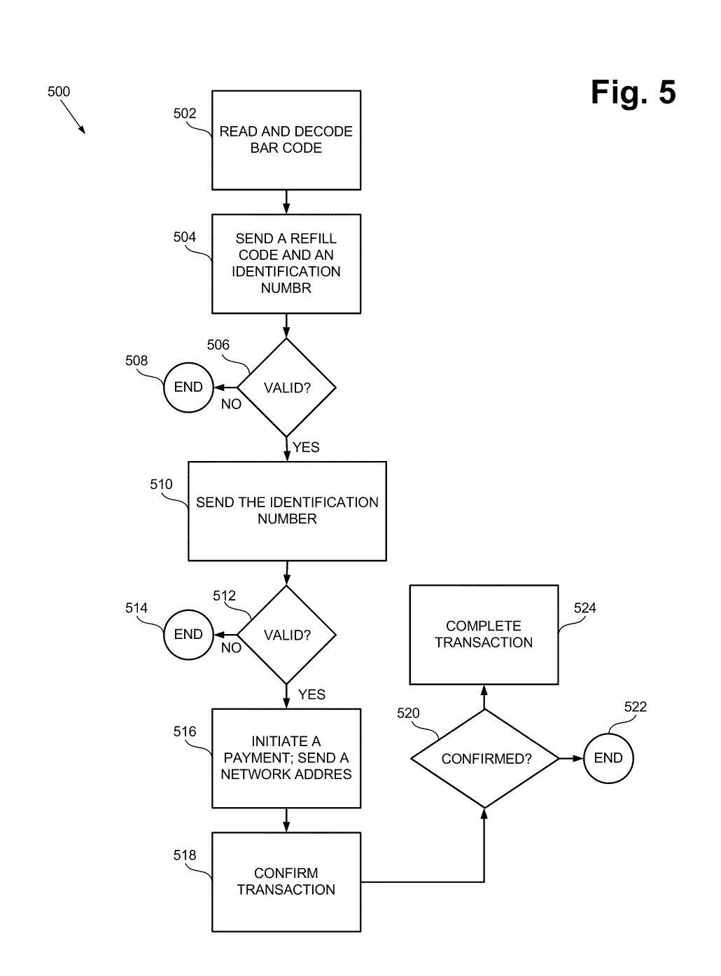

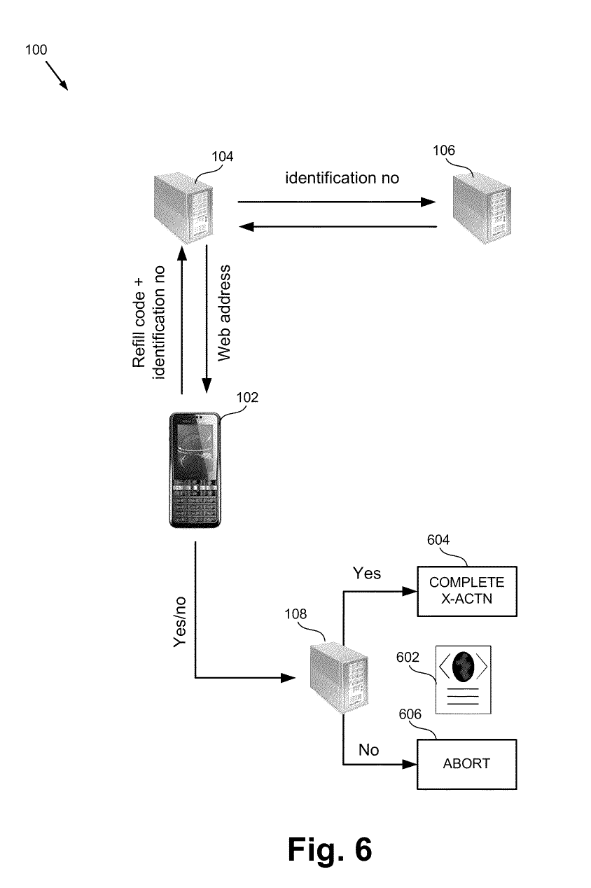

FIG. 5 is a flow diagram of an exemplary process 500 associated with refilling a prepaid account and with system 100. FIG. 6 illustrates process 500. For FIGS. 5 and 6, assume that payment information (e.g., user credit card number) is registered at IV device 106.

Assume that a user discovers that the amount of credit remaining on the user's prepaid account is not enough for the user to place a call. At a subway station, the user notices a poster with barcodes for refilling prepaid accounts for cellular phones. In addition, assume that user device 102 is powered on.

Process 500 may start at block 502, when the user scans the barcode with user device 102. For example, the user may point camera 218 at the barcode and scan the barcode via an application. In response, user device 102 may read and decode the barcode, generating the corresponding refill code (block 502). Subsequently, as illustrated in FIG. 6, user device 102 may send the refill code and an identification number (e.g., phone number) to gateway 104 (block 504). In some implementations that do not involve prepaid accounts for products and/or services not related to telephone services, an account information other than the identification number (e.g., name of an online game account, gym membership number, customer number for a store, etc.) may be sent along with the refill code to gateway 104.

Gateway 104 may determine whether the refill code is valid (block 506). If the refill code is not valid (block 506—NO), gateway 104 may end process 500 (circle 508). Ending process 508 may entail additional bookkeeping activities, such as notifying user device 102 of the error related to the refill code, or sending an email to an operator of system 100 about the error. If the refill code represents a valid dollar amount or credit amount for refilling, gateway 104 may send the identification number, the amount to be credited, and/or another type of account information to IV device 106 (block 510), as illustrated in FIG. 6.

At block 512, IV 106 device may determine whether the identification number/account information is valid (block 512). In some implementation, IV device 106 may include one or more databases of identification numbers, user account information, and/or payment information. Upon receipt of the identification number/account information from gateway 104, IV device 106 may perform a lookup of the phone number/account information in the databases and verify whether the phone number exists, the phone number correctly belongs to the user account, and crosscheck other types of account information.

If the identification number/account information is not valid (block 512—NO), IV device 106 may generate an error, and IV device 106 and/or gateway 104 may terminate process 500 (circle 514). Similarly to circle 508, gateway 104 and/or IV device 106 may perform appropriate bookkeeping activities in the event of invalid information.

If the identification number/account information is valid (block 512—YES), IV device 106 may retrieve payment information, such as a stored credit card number, and IV device 106 (or gateway 104) may initiate a payment for the credits for the prepaid account. In initiating the payment, IV device 106 and/or gateway 104 may send, to user device, a network address (e.g., web address) to which a browser/application on user device 102 may be directed. In FIG. 6, gateway 104 is shown as sending the web address to user device 102.

Based on the received network address, the browser on user device 102 may obtain a web page 602, which is provided via transaction device 108, associated with the network address. Web page 602 may request the user to confirm the payment transaction (block 518). If the user does not confirm the transaction (block 520—NO), the transaction may be aborted by, for example, one of gateway 104, IV server 106, or transaction device 108 (circle 522 and block 606). Otherwise (block 520—YES), the transaction may be completed (blocks 524 and 604). That is, the prepaid account may be refilled by the selected cash amount and the user's payment account (e.g., credit card account) may be debited by the corresponding amount.

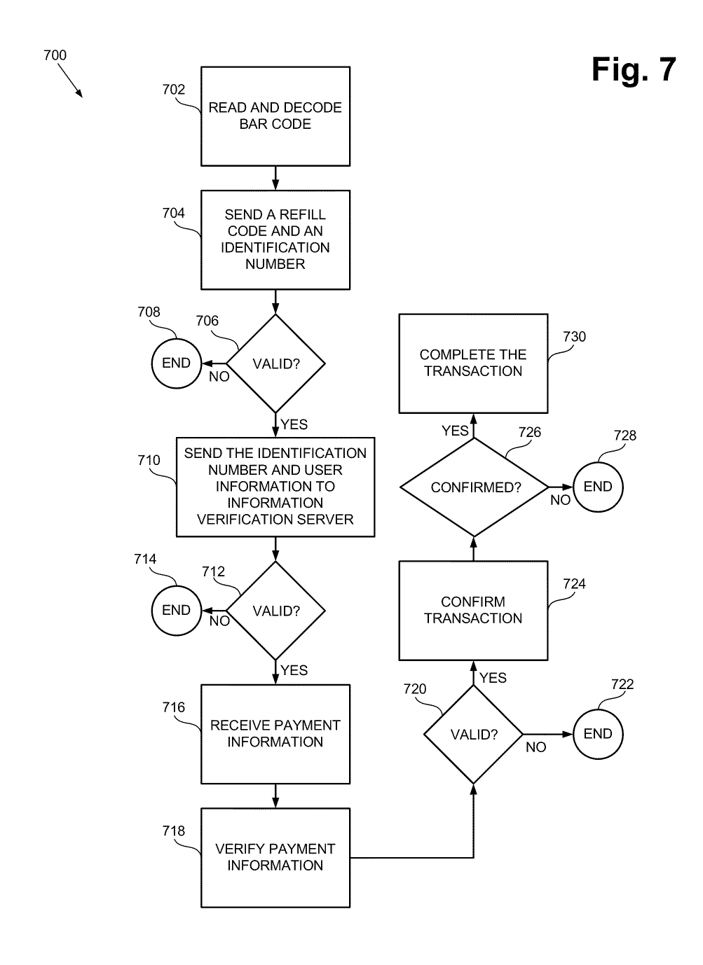

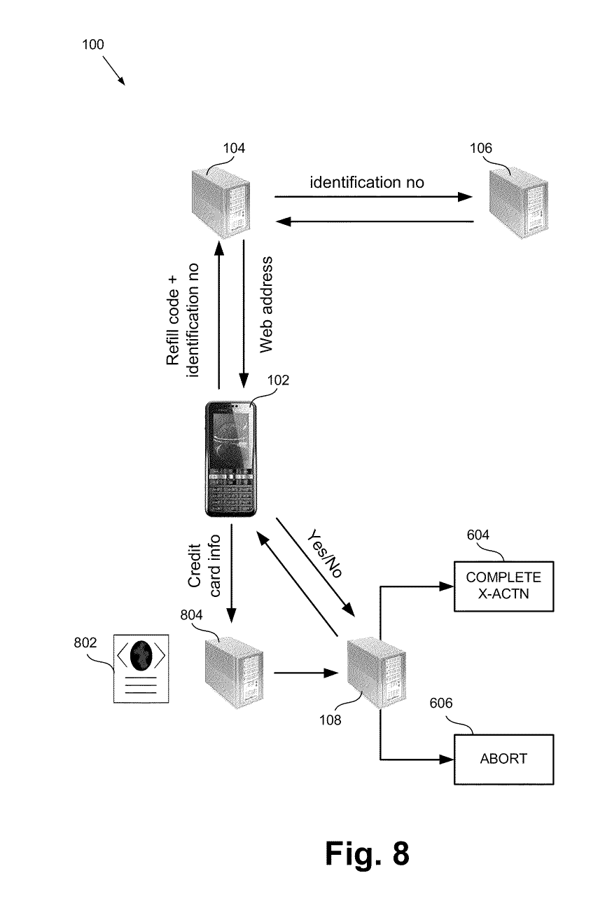

FIG. 7 is a flow diagram of another exemplary process 700 associated with refilling a prepaid account and associated with system 100. FIG. 8 illustrates process 700. For FIGS. 7 and 8, assume that payment information (e.g., user credit card number) is not registered at IV device 106. Assume that user device 102 is powered on, and the user is about to scan a barcode to replenish a prepaid account.

Process 700 may start at block 702, when the user scans the barcode with user device 102. In response, user device 102 may read and decode the barcode, generating the corresponding refill code (block 702). Thereafter, user device 102 may send the refill code and an identification number to gateway 104 (block 704), as shown in FIG. 8. In some implementations that involve prepaid accounts for products and/or services not related to telephone services, account information other than the identification number (e.g., name of an online game account, gym membership number, customer number for a store, etc.) may be sent along with the refill code to gateway 104.

Gateway 104 may determine whether the refill code is valid (block 706). If the refill code is not valid (block 706—NO), gateway 104 may end process 700 (circle 708). If the refill code represents a valid dollar amount or credit amount for refilling, gateway 104 may send the identification number, the amount to be credited, and/or another type of account information to IV device 106 (block 710). This is illustrated in FIG. 8.

At block 712, IV 106 device may determine whether the identification number/account information is valid (block 712). In some implementation, IV device 106 may include one or more databases of identification numbers, user account information, and/or payment information. Upon receipt of the identification number/account information from gateway 104, IV device 106 may perform a lookup of the identification number/account information in the databases and verify whether the identification number exists, the identification number correctly belongs to the user account, crosscheck other types of account information.

If the identification number/account information is not valid (block 712—NO), IV device 106 may generate an error, and IV device 106 and/or gateway 104 may terminate process 700 (circle 714). If the identification number/account information is valid (block 712—YES), IV device 106 may send, to user device, a network address (e.g., web address) to which a browser/application on user device 102 may be directed. In FIG. 8, gateway 104 is shown as sending the web address to user device 102.

Based on the received network address, the browser on user device may obtain a web page 802, which is provided via payment server 804, associated with the network address. Web page 802 may request the user to provide payment information (e.g., credit card number). Furthermore, upon receiving the information, payment server 804 may verify the payment information (block 718).

If the payment information is not valid (block 720), payment server 804, IV device 106, or gateway 104 may terminate process 700 (circle 722). Otherwise (block 720—YES), payment server 804 may notify transaction device 108 that the payment information is valid. In addition, payment server 804 may direct or redirect the browser at user device 102 to a web page at transaction device 108.

The web page may request the user to confirm the payment transaction (block 724). If the user does not confirm the transaction (block 726—NO), the transaction may be aborted by, for example, one of gateway 104, IV server 106, payment server 804, or transaction device 108 (circle 728 and block 606). Otherwise (block 726—YES), the transaction may be completed (blocks 730 and block 604). That is, the prepaid account may be refilled by the selected cash amount and the user's payment account (e.g., credit card account) may be debited by the corresponding amount.

### CONCLUSION

The foregoing description of implementations provides illustration, but is not intended to be exhaustive or to limit the implementations to the precise form disclosed. Modifications and variations are possible in light of the above teachings or may be acquired from practice of the teachings.

For example, in the above, a refill code is described as representing/corresponding to a dollar amount. In other implementations, a refill code may not necessarily be associated with or represent a dollar value. In these implementations, when the user is directed to a site to confirm a purchase a refill for a prepaid account, the user may be requested to enter the dollar amount or given an opportunity to specify the dollar amount to refill the prepaid account.

In the above, while series of blocks have been described with regard to the exemplary processes, the order of the blocks may be modified in other implementations. In addition, non-dependent blocks may represent acts that can be performed in parallel to other blocks. Further, depending on the implementation of functional components, some of the blocks may be omitted from one or more processes.

It will be apparent that aspects described herein may be implemented in many different forms of software, firmware, and hardware in the implementations illustrated in the figures. The actual software code or specialized control hardware used to implement aspects does not limit the invention. Thus, the operation and behavior of the aspects were described without reference to the specific software code—it being understood that software and control hardware can be designed to implement the aspects based on the description herein.

It should be emphasized that the term “comprises/comprising” when used in this specification is taken to specify the presence of stated features, integers, steps or components but does not preclude the presence or addition of one or more other features, integers, steps, components, or groups thereof.

Further, certain portions of the implementations have been described as “logic” that performs one or more functions. This logic may include hardware, such as a processor, a microprocessor, an application specific integrated circuit, or a field programmable gate array, software, or a combination of hardware and software.

No element, act, or instruction used in the present application should be construed as critical or essential to the implementations described herein unless explicitly described as such. Also, as used herein, the article “a” is intended to include one or more items. Further, the phrase “based on” is intended to mean “based, at least in part, on” unless explicitly stated otherwise.

What is claimed is:

1. A method comprising:
reading a barcode and decoding the barcode to obtain a refill code at a user device;
receiving an identification number and the refill code from the user device;
determining whether the refill code is valid;
determining whether the identification number is valid when the refill code is valid;
when the identification number is valid, initiating a payment transaction to refill a prepaid card account;
receiving a user confirmation of the payment transaction when the application is at the network address; and
completing the payment transaction and refilling the prepaid account when the user input confirms the payment transaction.

2. The method of claim 1, wherein initiating the payment transaction includes:
retrieving a credit card number registered to the identification number.

3. The method of claim 1, wherein receiving the user confirmation includes:
receiving a credit card number from a user when the credit card number is not registered to the identification number.

4. The method of claim 3, wherein completing the payment transaction includes:
charging a credit card account associated with the credit card number.

5. The method of claim 1, wherein receiving the user confirmation includes:
receiving indication, from a user, that the user approves the payment transaction.

6. The method of claim 1, wherein reading the barcode includes reading a two-dimensional barcode.

7. The method of claim 6, wherein reading the barcode includes reading a barcode printed on a magazine or a poster.

8. The method of claim 1, wherein determining whether the refill code is valid includes:
determining whether the refill code represents a valid dollar amount.

9. The method of claim 1, wherein determining whether the refill code is valid includes determining, by a gateway, whether the refill code is valid, and
wherein determining whether the identification number is valid includes determining, by a remote device, whether the identification number exists at the remote device.

10. A device comprising:
a subscriber identity module (SIM) card associated with a telephone number;
a network interface to communicate with a gateway; and
a processor configured to:
decode a barcode to obtain a refill code;
send the telephone number and the refill code to the gateway via the network interface;
receive, from the gateway, a network address at which a confirmation page for a payment transaction is presented when the gateway validates the refill code and a remote device validates the telephone number;
receive, via a browser installed on the device, a request to confirm the payment transaction at the network address; and
receive user input confirming the payment transaction; and
relay, to the network address, the user input that completes the payment transaction and refills a prepaid account.

11. The device of claim 10, wherein the prepaid account includes an account that is associated with a prepaid card.

12. The device of claim 11, wherein the prepaid card includes a prepaid SIM card.

13. The device of claim 10, wherein the device comprises a cellular phone.

14. The device of claim 10, wherein the processor is further configured to:
receive a credit card number of a user when the credit card number is not registered to the telephone number.

15. The device of claim 10, further comprising:
a camera to scan the barcode.

16. A device comprising:
a network interface; and
a processor to:
receive a refill code and an identification number from a user device via the network interface;
validate the refill code;
send the identification number to a server device when the refill code is valid;
receive a network address from the server device when the server device determines that identification number is valid and initiates a transaction to refill a prepaid card account, the network address being associated with a web page via which the user device confirms the payment transaction; and
relay the network address to the user device.

17. The device of claim 16, wherein the user device includes a cellular telephone.

18. The device of claim 16, wherein the prepaid card account includes an account associated with a subscriber identity module (SIM) card.

19. The device of claim 16, wherein the web page is configured to:
receive user input that aborts the transaction.

20. The device of claim 16, wherein the web page is configured to:
receive a credit card number that is registered to the identification number.
